(19) United States
(12) Patent Application Publication
(10) Pub. No.: US 2010/0050444 A1
(43) Pub. Date: Mar. 4, 2010

(54) MATBOARD CUTTING SYSTEM INCLUDING A CARTRIDGE-MOUNTED BLADE

(75) Inventors: Walter D. Krein, Monroe, WA (US); David Andrew Weber, Snohomish, WA (US); Robert A. Walters, Mill Creek, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: WIZARD INTERNATIONAL, INC., Mukilteo, WA (US)

(21) Appl. No.: 12/203,885

(22) Filed: Sep. 3, 2008

(51) Int. Cl. B26D 7/00

(52) U.S. Cl. 30/296.1

(57) ABSTRACT

Systems and methods for cutting matboard at an angle between 5 and 90 degrees with a replaceable cartridge are described. The system includes a blade, blade cartridge, and footblock. The blade is double-edged and double-beveled and designed to fasten into the cartridge without slipping. The blade cartridge is secured in the footblock. The cartridge is designed to hold the blade at an angle to the material to be cut and to cut by pulling or pushing the blade through the material. Because the blade is secured into the cartridge, the position and angle and depth of the blade relative to the material remain constant.

### BACKGROUND

Cutting matboard (“mat”) for use in picture framing is an important aspect of the quality of the overall product when a completed picture is framed and hung for display. While not the primary focus of a framed picture, the matboard subtly accentuates and enhances the picture contained within. Cutting matboard by hand is a time-consuming process that requires a high level of skill and, even then, can result in an uneven angle of cut across the four edges of a typical square cut-out.

In an effort to speed up the process of cutting matboard and produce a more consistent cut, automated matboard cutting machines have been developed. A typical matboard cutting machine will cut the matboard at a 45° angle (with respect to the plane of the matboard surface). Cutting is typically accomplished by pushing a blade around all sides of the desired shape. Matboard cutting machines have also been produced that cut at an angle perpendicular to the matboard.

Matboard cutting machines typically consist of a number of parts. A head assembly contains a cutting blade and attaches to a gantry, or other apparatus that moves the head in the shape of the desired cut. Typically, the blade is firmly embedded within the housing of a portion of the head called the footblock, and changing the blade is a painstaking and time-consuming endeavor. The time and effort required to change a blade can lead to fewer blade changes per number of cuts, leading to less crisp cutting lines as the blade wears.

One technology has provided an improved method for changing blades that includes the incorporation of a blade cartridge in the footblock. A cartridge containing a cutting blade is inserted and locked into the footblock, with the cutting edge of the blade protruding below the footblock. As the head and footblock are moved in the desired shape of the cut, the blade is positioned in the head through the cartridge and footblock. Changing a dull blade is simplified, as the cartridge need only be removed, the blade replace, and the cartridge reinserted, a process that can be completed relatively quickly.

Presently, blade cartridges only cut matboard at a 45° angle, a limitation resulting from the mechanism by which the blade is secured in the footblock. Particularly, the blade is inserted in a cartridge at a 45° angle into the footblock, with the blade being flush against the bottom edge of the 45° cartridge passage of the footblock. When fully inserted, the blade and cartridge are then cam-locked to produce a large frictional force on both the cartridge and blade that produces the required stabilization of the blade for high-speed and repeated cutting.

The matboard cutting industry would greatly benefit from a technology that combines the ability to cut at a non-45° (e.g., 90°) angle combined with the simplicity of a blade cartridge.

### SUMMARY

Systems and methods for cutting matboard at an angle between 5 and 90 degrees with a replaceable cartridge are described.

In one aspect, a blade cartridge for use in a matboard cutting system is provided that includes an elongated cartridge body that includes a blade cavity capable of closely receiving a blade, the blade cavity including means for fastening the blade securely at an azimuthal angle of between 5 and 90 degrees, where the cartridge is capable of being inserted into and secured in a footblock.

In another aspect, a matboard cutting system is provided that includes a blade; an elongated cartridge including a blade cavity capable of closely receiving the blade, the blade cavity including means for fastening the blade securely at an azimuthal angle of between 5 and 90 degrees; a footblock having a cartridge slide capable of receiving the cartridge and including means for securing the cartridge such that the blade projects below the bottom of the footblock; and a means for moving the footblock so that the blade travels along a cutting path.

In another aspect, a paper cutting system is provided that includes a blade having a double-edged cutting tip; a cartridge including a blade cavity capable of receiving the blade and securing the blade at an azimuthal angle of about 90 degrees; a footblock having a cartridge slide capable of receiving the cartridge and including means for securing the cartridge such that the blade projects below the bottom of the footblock; and a gantry attached to the footblock and capable of moving the footblock so that the blade travels along a desired cutting path.

In another aspect, a method for cutting matboard is provided that includes inputting into a system control device a desired shape to be cut in a matboard, the system control device being capable of controlling the movement of a matboard cutting system and moving the matboard cutting system as a result of the input into the system control device, such that matboard is cut in the desired shape, where the matboard cutting system includes a blade; an elongated cartridge including a blade cavity capable of closely receiving the blade, the blade cavity including means for fastening the blade securely at an azimuthal angle of between 5 and 90 degrees, a footblock having a cartridge slide capable of receiving the cartridge and including means for securing the cartridge such that the blade projects below the bottom of the footblock; and a means for moving the footblock so that the blade travels along a cutting path.

In another aspect an elongated blade for use in a matboard cutting device is provided that includes two cutting edges, each cutting edge having a double-beveled shape and a first vacancy and a second vacancy used to retain the blade in a matboard cutting device, where at least one of the first vacancy and the second vacancy are offset from a centerline bisecting the length of the blade.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic illustration of a mat being cut with a blade at a 45° angle, as is known in the prior art;

FIG. 2A is a schematic illustration of a blade cutting a mat at a 90° angle in accordance with aspects of the present invention;

FIG. 2B is a perspective view of a blade formed in accordance with aspects of the present invention;

FIG. 3 is a perspective view of an exemplary footblock assembly formed in accordance with aspects of the present invention;

FIG. 4 is a perspective view of the footblock of FIG. 3 with the blade cartridge removed from the footblock;

FIG. 5 illustrates an exploded view of the footblock of FIGS. 3 and 4;

FIG. 6A is a perspective view of a blade cartridge formed in accordance with aspects of the present invention;

FIG. 6B is an end view of the blade cartridge of FIG. 6A showing multiple blade angles;

FIG. 7 is an exploded view of the blade cartridge of FIG. 6A;

FIG. 8 is another exploded view of the blade cartridge of FIG. 6A;

FIG. 9 is a perspective view of a blade cartridge of the prior art;

FIG. 10 is another perspective view of the blade cartridge of the prior art;

FIG. 11 is a perspective view of a blade cartridge assembly of the prior art; and

FIG. 12 is a perspective view of a footblock assembly of the prior art.

### DETAILED DESCRIPTION

The following description provides examples of systems and methods for cutting matboard at a nonstandard angle (i.e., not a “standard bevel” of 45°). The disclosed matboard cutting system utilizes several aspects that enable such cutting. A blade-containing cartridge is inserted into a footblock capable of receiving the cartridge, and a double-edged, double-beveled blade in the cartridge is pressed into the matboard at an angle between 5 and 90 degrees, after which the blade is either pushed or pulled through the matboard, cutting the desired pattern with a matboard edge bevel of equal angle to the angle of the blade in the cartridge.

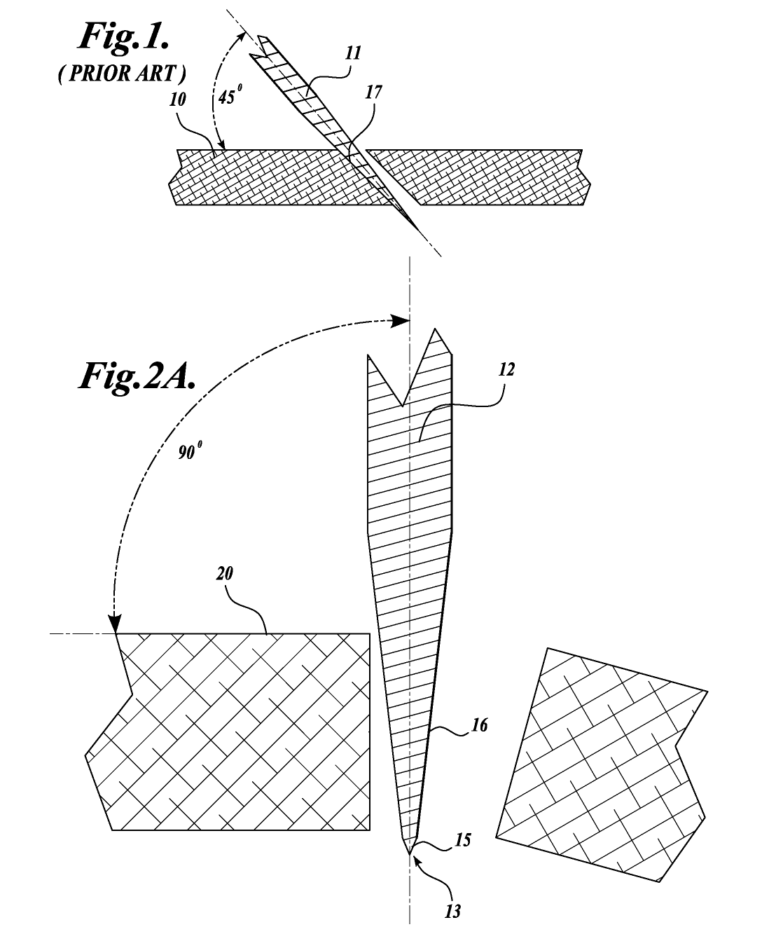

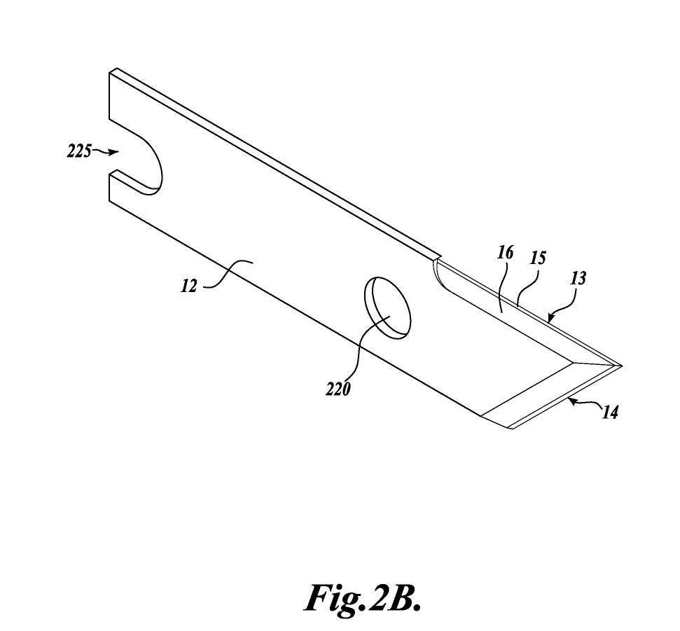

Embodiments of the present invention will now be described with reference to the accompanying drawings, where like numerals correspond to like elements. The system of the invention will be better understood by first describing the type of cut achieved by a prior art cutting system (FIG. 1) and the type of cut achieved by the present system described herein (FIG. 2A). In FIG. 1, the matboard 10 is cut by the prior art blade 11 disposed at a 45° angle from the plane of the matboard, resulting in a discarded piece of matboard 15. The result is a cut matboard having a 45° beveled edge 17. The system described herein cuts in a manner illustrated in FIG. 2A, where a matboard 20 is cut by a double-beveled blade 12 at a non-45° angle (illustrated FIG. 2A as 90° measured from a centerline bisecting the blade 12). An additional difference between the prior art and the system described herein is the direction of cutting, which will be described further below. The cutting systems used in the prior art are only capable of cutting in one direction—meaning that, in FIG. 1, the prior art blade 11 would only cut out of the plane of the figure towards the viewer or away from the viewer. The present system is capable of cutting in both forward and rearward directions, meaning that, in FIG. 2A, the blade 12 can move out of the plane of the paper both towards the viewer and away from the viewer.

Referring now to FIG. 2B, a perspective view of a blade 12 useful in the present system. The blade 12 has a first cutting edge 13, and a second cutting edge 14, each of which is a double-beveled edge, as can be seen in FIG. 2A. The double bevel, having a first bevel 15 and a second bevel 16, allows the blade to remove cut material efficiently away from the cutting edges 13 and 14, and thus allows for more efficient operation of any cutting system utilizing such a blade 12. As will be described in more detail later, vacancies 220 and 225 allow for posts 230 and 234 to affix the blade 12 into a cartridge 110 for use in a cutting system 100. The size (length and depth) of the cutting edges 13 and 14, as well as the angle of the bevels, may be adjusted depending on the cutting angle at which the blade 12 will be used. For example, a cut at 5 degrees will be more efficient with larger cutting edges 13 and 14 than a cut at 90 degrees, primarily because more mat is cut when the cutting angle is shallow.

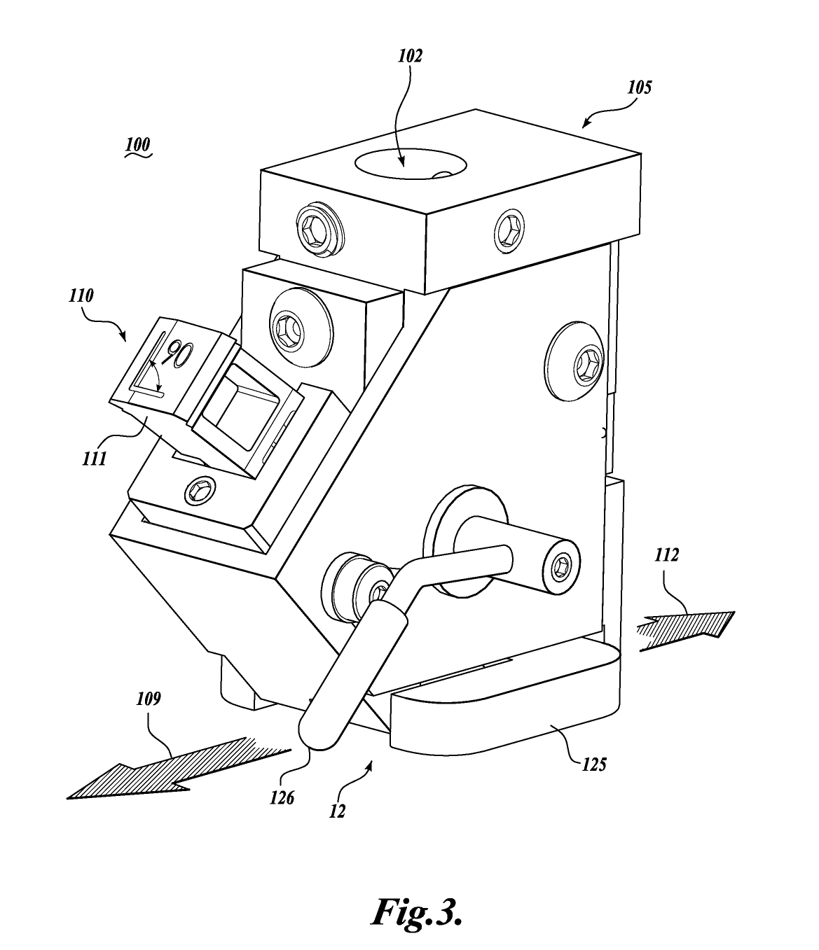

The present system will now be described further, beginning with FIG. 3. A footblock assembly 100 is illustrated. The footblock assembly is capable of being attached to a head assembly (not pictured) through the opening 102 at the top of the footblock assembly 100. The head is then further attached to a gantry (not pictured) capable of positioning the head and footblock assembly 100 and maneuvering the footblock assembly 100 through the desired cutting motions. Such cutting technology (i.e., use of a head and gantry) is well known to those of skill in the art and will not be described in detail herein. The footblock assembly 100 consists of two primary structures—a footblock 105 and a blade cartridge 110. The cartridge 110 is typically in the shape of an elongated rectangular box that includes a blade 12 (not in view). The arrows 109 and 112 indicates a typical direction of travel for such a footblock assembly 100, which is typically towards the elongated cartridge 110 (“pulling” the blade 12 in direction of arrow 109) or away from the elongated cartridge 110 (“pushing” the blade 12 in direction of arrow 112). Such multidirectional travel is partially enabled by the double-edged, double-beveled blade 12.

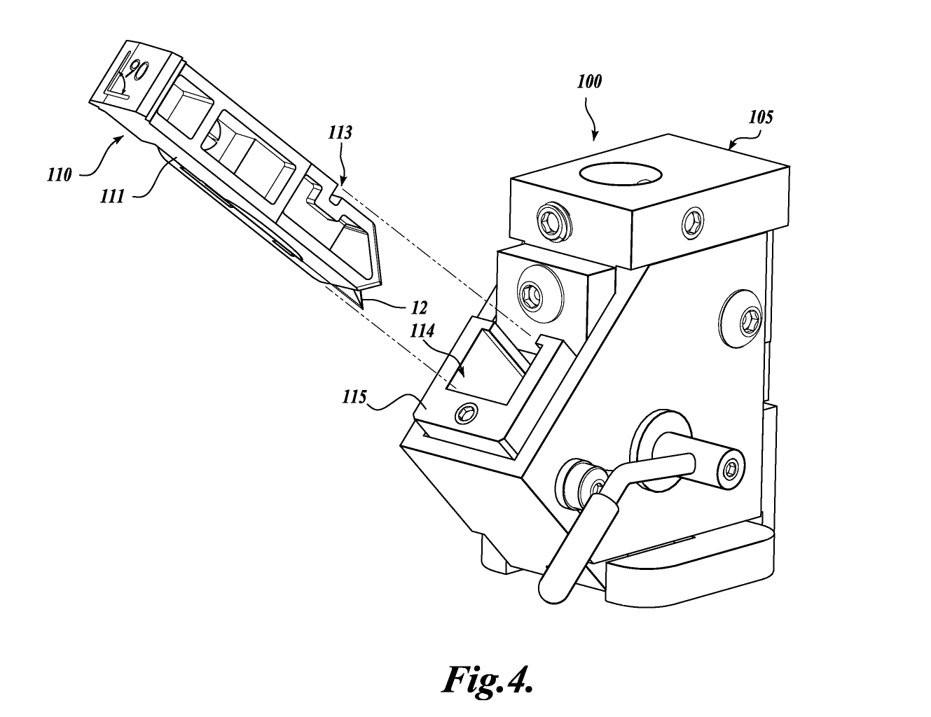

FIG. 4 illustrates a representative footblock assembly 100 with the cartridge 110, removed from the footblock 105. When removed from the footblock 105, the cartridge 110 shows an exposed blade 12. The cartridge 110 fits into the footblock 105 through a cartridge passage 114 defined by a generally U-shaped cartridge slide 115.

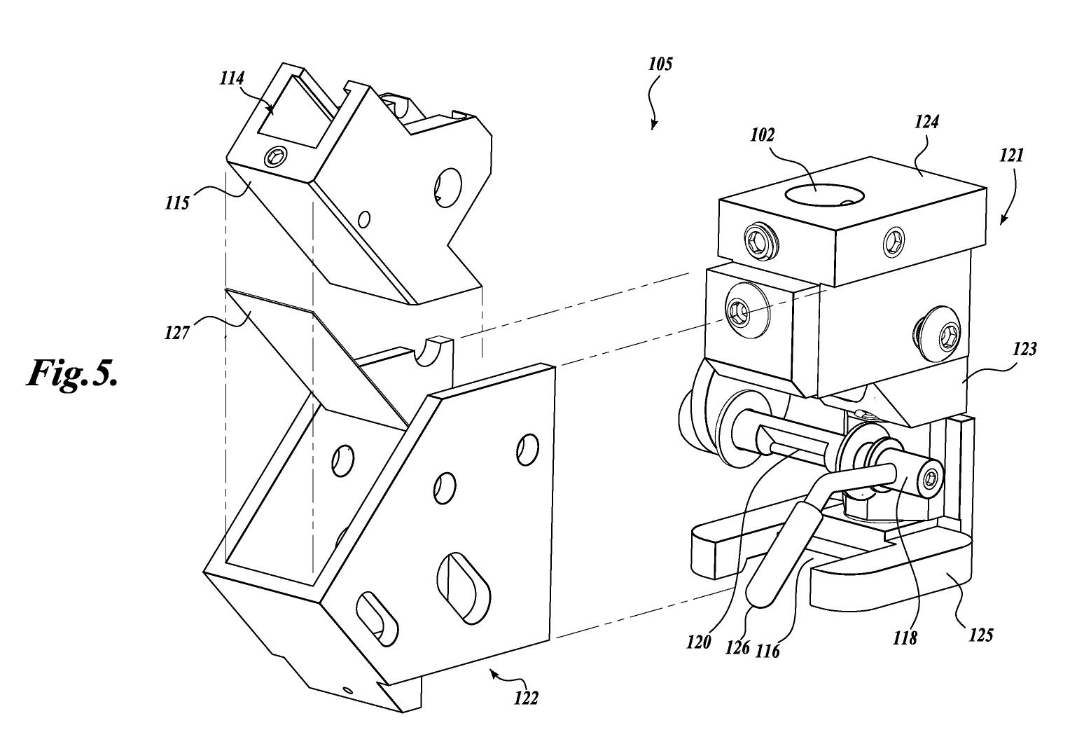

FIG. 5 is an exploded view of a representative footblock 105 showing the cartridge slide 115 and an inner footblock 121 disposed within an outer, generally U-shaped housing 122. Intermediate the cartridge slide 115 and the housing 122 is a friction-reducing bearing surface 127 that facilitates the sliding of the slide 115 within the housing 122. In one representative embodiment, the bearing surface 127 is manufactured from an ultra-high molecular weight (UHMW) material, such as UHMW polyethylene. UHMWs are highly durable and have a high abrasion resistance, low coefficient of friction, and a high impact resistance. The UHMW bearing surface 127 allows for long wear time between replacing the surface 127, thus saving both time and cost for a typical user. Particularly when compared to the bearing surfaces used in the prior art, which include smooth metal, rollers, and ball bearings.

The inner footblock 121 includes a main body portion 123 with a connection block or plate 124 at the top of the footblock, having a hole 102 formed therein for attachment to a head assembly via hole 102, which in turn is carried by a gantry. A base 125 is located at the bottom of the body portion 123 to slide along the surface of the mat being cut.

Inside the footblock 105, a cam mechanism 120 locks and unlocks the cartridge 110, when inserted. A pivot shaft 118 is attached to the cam mechanism 120 and a manually graspable lever 126 protrudes from the pivot shaft to rotate the cam mechanism 120 into and out of locking engagement with a cross slot 113 in the upper portion of the cartridge 110. The user locks and unlocks the cartridge 110 by operation of lever 126. In one embodiment, the cam mechanism 120 is spring-loaded and locks the cartridge 110 in place once the cartridge is inserted a predetermined distance down the cartridge passage 114. A bottom opening 116 in base 125 allows a cartridge blade (not shown) to protrude below the surface of the base 125 when the cartridge 110 is inserted.

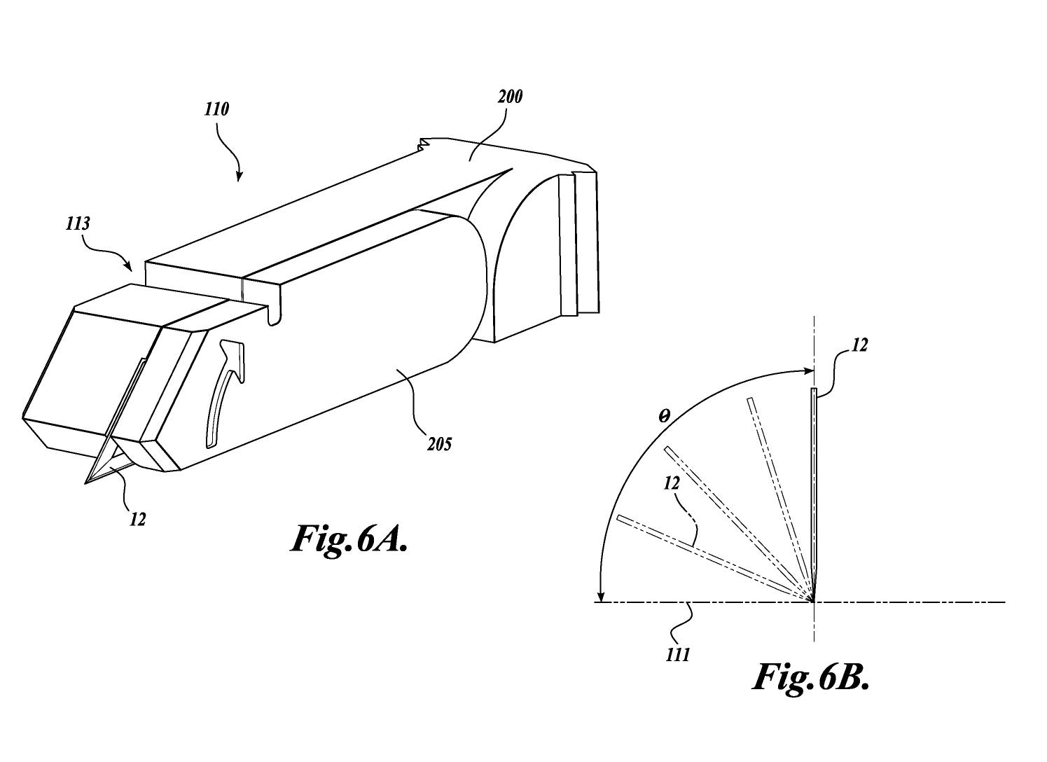

The cartridge 110 will now be described in more detail. A representative cartridge 110 includes a rectilinear cartridge body 200, a thin blade 12, and a cartridge door 205, as illustrated in FIG. 6A. The blade 12 is typically fastened in the elongated direction of the cartridge 110, thus providing stability to the blade 12. The blade 12 in the representative cartridge 110 illustrated in FIGS. 6A, is at an azimuthal angle of 90° with respect to the bottom surface 111 of the cartridge 110.

FIG. 6B is an end view of the cartridge 110 illustrated in FIG. 6A, with the cartridge body 200 and cartridge door 205 removed, and shows the azimuthal angle of the blade 12 (defined by a bisecting centerline) in relation to the bottom surface 111 of the cartridge 110, denoted by θ. Various blade positions at different azimuthal angles are illustrated in phantom. The azimuthal angle of the blade is equal to the angle of cut made using the blade 12 in a cartridge 110.

It will be appreciated by those of skill in the art that the cartridge 110 described herein can be modified to provide other cutting angles if the cartridge body 200, cartridge door 205, and the remainder of the cartridge 110 are re-configured to accommodate such an angled blade 12, as described in more detail below. Additionally, in operation of the system 100, the throw, or distance the blade is pressed into the mat, is longer for more shallow azimuthal angles of the blade 12 because the thickness of the mat that must be cut is greater. Thus, a shallow cutting angle (e.g., 30 degrees) requires a longer throw when compared to a steeper angle (e.g., 90 degrees).

Cartridges having azimuthal blade angles (i.e., cutting angles) of from 5 to 90 degrees are useful in the system. A preferred cutting angle is 90°. The remainder of the figures will be described as pertaining to the exemplary 90° configuration for the blade 12 in the cartridge 110, as illustrated in FIG. 6A.

In a preferred embodiment, the system includes a blade having a double-beveled cutting tip, a blade held in a cartridge at an azimuthal angle of about 90 degrees, and a gantry attached to the footblock.

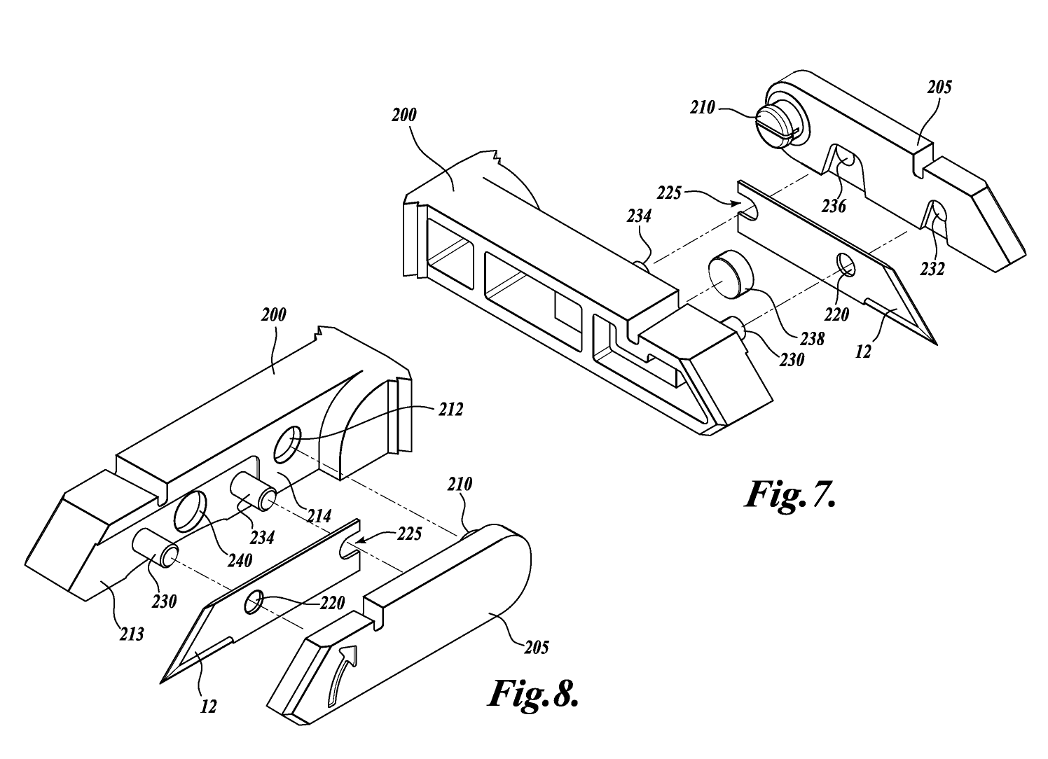

FIGS. 7 and 8 show exploded views of the exemplary cartridge 110 illustrated in FIG. 6A. In this exemplary embodiment, the cartridge body 200 and cartridge door 205 are joined by a cartridge door hinge post 210 protruding from the door that fits into recessed opening 212 on the cartridge body 200. The hinge 210 allows the cartridge door 205 to rotate about the hinge 210 in order to expose the blade cavity 213 that is in the form of a depression in the surface 214 of the body facing the door. The blade 12 is secured in the blade cavity 213 such that when in place, the surface of the blade 12 facing the door 205 is co-planar with the surface 214 of the body. Other means for attaching the cartridge body 200 and cartridge door 205 are contemplated, including slidably attaching the door 205, using a snap-in door 205 that is separable from the body 200, and other attachment means known to those of skill in the art.

In one embodiment, posts in the interior of the cartridge 110 pass through holes, or other vacancies, in the blade 12 to secure the blade 12 for cutting. In a representative embodiment, the blade 12 has two cut-out portions, a forward circular through-hole 220 and rear notch 225, which help to secure the blade 12 into the cartridge 110 when assembled. A front post 230 protruding from the cartridge body 200 engages through the front circular cut-out 220 of the blade 12 and into a close fitting front blind opening 232 on the cartridge door 205. Similarly, the rear post 234 protrudes from the cartridge body 200 to extend through the rear notch 225 of the blade 12 and engages into a rear blind door 236 on the cartridge door 205.

The cut-out portions 220 and 225 on the blade are typically positioned offset from a centerline bisecting the length of the blade such that a user can only attach the blade 12 to the cartridge body 200 in the correct position. The posts 230 and 234 are similarly offset in the cartridge body 200 so as to receive the blade 12 only in the correct position for proper cutting. The combination of the posts 230 and 234 and the cut-out portions 220 and 225 prevent improper mounting of the blade 12, and thus improve the ease of operation of the cartridge 110 and the system 100.

In a representative embodiment, loading of the blade 12 into the cartridge 110 is facilitated by a circular or disc-shaped magnet 238 illustrated in FIG. 7. The magnet 238 attracts the metallic blade 12 and the attraction helps to situate the blade 12 into the blade cavity 213. The magnet 238 resides in the magnet cavity 240, illustrated in FIG. 8, formed in the body 200 and can be held in place by any convenient means. It will be appreciated that the posts 230 and 234 render the magnet 238 redundant in function (holding the blade 12 in place), yet the magnet 238 still provides an additional degree of ease for the user when loading a blade 12.

The previous figures (e.g., FIGS. 6A-8) have been described using an exemplary blade 12 azimuthal angle of 90 degrees. As illustrated in FIG. 6B, the azimuthal angle is variable, thus enabling cartridges 110 to be manufactured with different cutting angles. An adjustment in blade 12 azimuthal angle from the exemplary 90 degree configuration typically requires the design of the cartridge 110 to be modified from the design illustrated in FIGS. 6A-8. Such a modification will typically include an adjustment in the body face surface 214 and associated blade cavity 213 within the cartridge body 200 such that the azimuthal angle of the blade 12 is maintained when the blade 12 is affixed in the blade cavity 213. In this regard, the body face may be rotated relative to bottom surface 111 of the cartridge 110. The cartridge door 205, hinge 210, posts 203 and 234, openings 212, 232, and 236 would all be similarly adjusted to accommodate the angle of the blade 12 such that the functions of such parts in securing and positioning the blade 12 are maintained for any azimuthal angle of the blade 12 as they were described above for the 90 degree blade angle.

It will be appreciated that the parts described in relation to the cartridge 110 can be manufactured from several different materials. In a representative embodiment, the cartridge body 200 and cartridge door 205 are manufactured from a polymer, preferably a polycarbonate. Also, the body 200 can be of substantially hollow construction. The blade 12 is typically manufactured from a metal to preserve sharpness and improve durability. The posts 230 and 234, as well as recessed openings 232 and 236 in the blade cavity 213, can also be made from metal or any other material known to be robust when subject to repeated loads over time. By manufacturing the components of the cartridge 110 that hold the blade 12 in place using robust materials, the system improves durability and the length of time between changing blades 12. Additionally, the cutting accuracy of the system is maintained if the blade 12 is well secured in the cartridge 110 with robust, non-deformable materials. Such a feature is important not only for durability but also to preserve the cutting angle intended by the user throughout repeated cuttings.

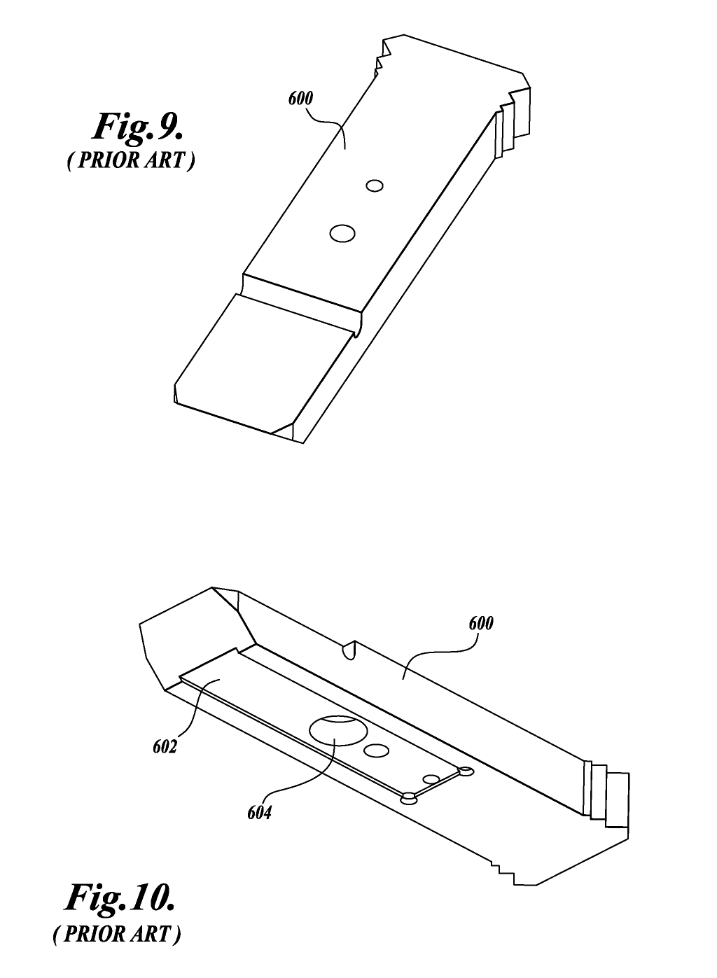

As mentioned above, the use of a cartridge 110 in a footblock is known in the art. However, the use of 90° and other non-45° cutting blades in cartridges is not known. The current state of the art with regard to blade cartridge mat cutters can be better understood with reference to FIGS. 9 and 10. FIGS. 9 and 10 each illustrate perspective views of a prior art blade cartridge 600. The underside of the blade cartridge 600 is shown in FIG. 10, where a shallow blade cavity 602 is shown, along with a recessed space 604 that contains a magnet for mounting a blade. The blade 605 is exclusively mounted by a magnet in cartridges 600 of the prior art.

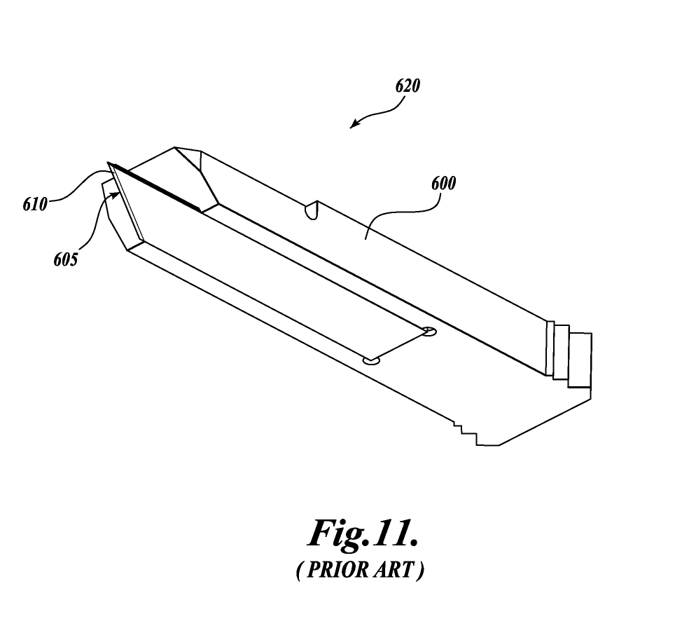

In FIG. 11, a cartridge assembly 620 includes a blade 605 sitting in the blade cavity 602, held in place by a magnet (not shown) disposed within space 604. The blade 605 has a single-edge cutting edge 610, as prior art cutting systems are only designed to cut in one direction.

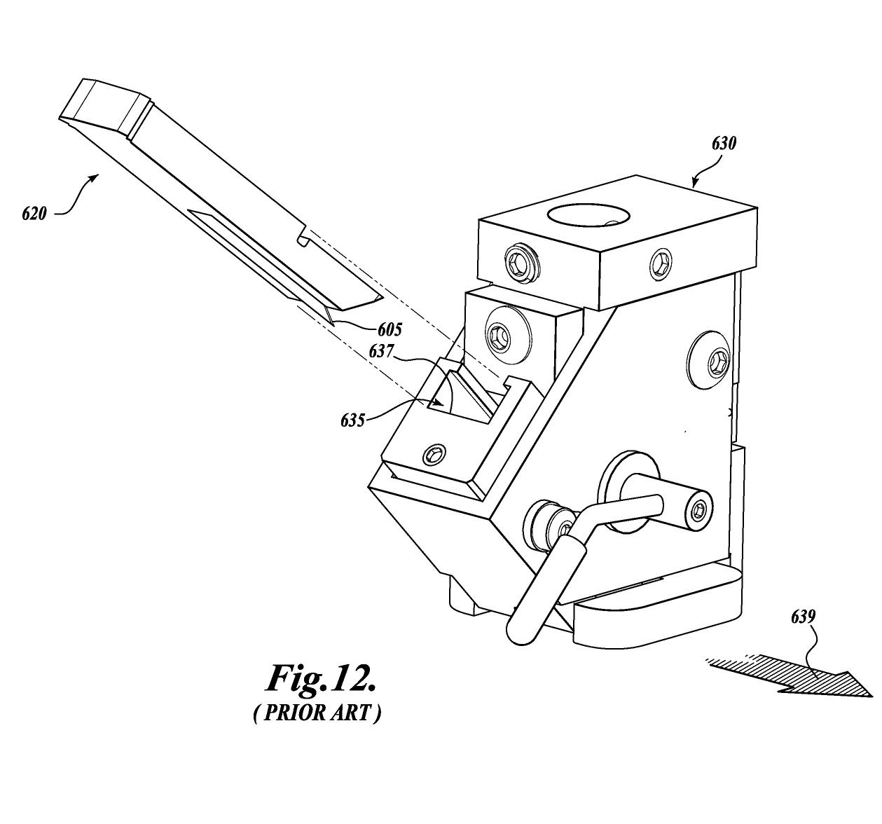

FIG. 12 shows a prior art footblock 630 capable of receiving a prior art cartridge 620. The blade 605 is disposed at the bottom surface of the cartridge 620. When inserted into the footblock 630 via the cartridge passage 635, the blade 605 is flush with the adjacent surface 637 of the cartridge passage 635, and thus, the azimuthal angle of the blade is effectively 0 degrees. When the cam locking mechanism (not shown) is engaged, the force from the cam presses downward on the cartridge 620, seeking to force the cartridge 620 against surface 637, thus seeking to immobilize the blade 605 with frictional force. When assembled, the footblock 630 and blade 605 are moved in the direction of arrow 639 when cutting (determined by the direction of the cutting surface of the single cutting edge 610 of the blade 605).

The system described herein does not benefit from the frictional stabilization of the blade 12 through cam-locking pressure, as described above with regard to the prior art in FIG. 12. Thus, the blade 12 is secured through the use of improved materials for affixing the blade 12, including the pegs 230 and 234, as well as the cut-outs 220 and 225 on the blade 12. The benefit obtained by the system described herein is that the blade 12 can be positioned at various azimuthal angles because the angle at which the blade cuts the mat is not defined by the angle of the cartridge passage 114, but is defined by the angle of the blade 12 in the cartridge 110. Cartridges 110 can be manufactured with different (i.e., non-45 or 90 degree) cutting angles, as described above, for use in the system, and to change between cutting angles is simply a matter of changing cartridges. In prior art cartridge systems, the angle is not changeable using a different type of cartridge, such as cartridge 600, because the angle of cut is defined only by the angle of the cartridge passage 635.

Other prior art is known that allows for a cutting machine to be changed from cutting at 45° to cutting at 90°, but such a machine requires a lengthy and expensive transition of parts at the footblock of the cutting machine. The ease at which the system described herein achieves variable angle cutting and blade replacement provides greatly improved cutting abilities (with regard to angles) and a significant savings of both time and money for users when replacing blades due to wear or the need for a different angled cut.

In a typical method of the invention, the above-described system is used for cutting matboard. The footblock assembly 100 is attached to, for example, a gantry, which moves the footblock assembly 100 in the desired cutting motions. The gantry is typically controlled by a system control device, such as a computer running a program designed to translate a pattern inputted by a user into the necessary gantry motions for moving the footblock assembly 100 such that the blade 12 produces the desired matboard cut.

The blade 12 will cut the matboard at an angle that is defined by the azimuthal angle at which the blade 12 is held in the blade cartridge 110. An exemplary angle is 90°, or substantially perpendicular to the matboard surface. Such a “straight cut” will produce a very different aesthetic appearance of a picture framed with the matboard than a “standard 45° bevel” would produce.

So as to allow the double-edged blade 12 to properly penetrate the matboard to be cut, a typical cutting process includes an initial dwell time after the blade 12 punctures the matboard and before the gantry begins moving the blade 12 and footblock assembly 100 in the desired shape. A typical dwell time is less than one second, although it will be appreciated that the length of the dwell time will be affected by the thickness of the matboard, the azimuthal angle of the blade 12, and the sharpness of the double-beveled cutting surfaces of the blade 12.

When moving during matboard cutting, the footblock assembly 100 typically moves substantially in the directions indicated by the arrows 109 and 112 in FIG. 3. Deviations from the exact directions illustrated are necessary for cutting non-square shapes.

While illustrative embodiments have been illustrated and described, it will be appreciated that various changes can be made therein without departing from the spirit and scope of the invention.

The embodiments of the invention in which an exclusive property or privilege is claimed are defined as follows:

1. A blade cartridge for use in a matboard cutting system, comprising:
an elongated cartridge body comprising a blade cavity capable of closely receiving a blade, the blade cavity comprising means for fastening the blade securely at an azimuthal angle of between 5 and 90 degrees, wherein the cartridge is capable of being inserted into and secured in a footblock.

2. The blade cartridge of claim 1, further comprising a blade fastened in the blade cavity.

3. The blade cartridge of claim 2, wherein the blade is secured in the cartridge by projections carried by the cartridge body that protrude through close fitting vacancies in the body of the blade.

4. The blade cartridge of claim 2, wherein the blade is a double-edged blade.

5. The blade cartridge of claim 1, wherein the azimuthal angle is about 90 degrees.

6. The blade cartridge of claim 1, wherein the blade cavity is formed by a cartridge body and a cooperating cartridge door that is moveable relative to the cartridge body between an open position providing access to the blade cavity and a closed position wherein the cartridge door overlies the blade cavity.

7. The blade cartridge of claim 6, wherein a shallow depression is formed in the cartridge body for receiving the blade.

8. The blade cartridge of claim 1, further comprising a cross-slot formed in the cartridge capable of lockingly engaging a cam mechanism in the footblock.

9. A matboard cutting system comprising:
a blade;
an elongated cartridge comprising a blade cavity capable of closely receiving the blade, the blade cavity comprising means for fastening the blade securely at an azimuthal angle of between 5 and 90 degrees;
a footblock having a cartridge slide capable of receiving the cartridge and comprising means for securing the cartridge such that the blade projects below the bottom of the footblock; and
a means for moving the footblock so that the blade travels along a cutting path.

10. The cutting system of claim 9, wherein the means for moving the footblock is capable of moving the footblock in a first direction or a second direction in a plane parallel to the bottom of the footblock, the first direction being towards the elongated cartridge when secured in the footblock and the second direction being opposite of the first direction.

11. The cutting system of claim 10, wherein the blade has a double-edged tip to facilitate cutting in both the first direction and the second direction.

12. The cutting system of claim 9, wherein the blade is at an azimuthal angle of about 90 degrees.

13. The cutting system of claim 9, wherein the blade cavity is formed by a cartridge body and a cooperating cartridge door that is moveable relative to the cartridge body between an open position providing access to the blade cavity and a closed position wherein the cartridge door overlies the blade cavity.

14. The cutting system of claim 13, wherein a shallow depression is formed in the cartridge body for receiving the blade.

15. The cutting system of claim 9, further comprising a bearing surface positioned within the footblock between a bottom surface of the cartridge slide and the footblock, wherein the bearing surface is friction-reducing surface manufactured from an ultra-high molecular weight polymer.

16. The cutting system of claim 15, wherein the ultra-high molecular weight polymer is a polyethylene.

17. A paper cutting system comprising:
a blade having a double-edged cutting tip;
a cartridge comprising a blade cavity capable of receiving the blade and securing the blade at an azimuthal angle of about 90 degrees;
a footblock having a cartridge slide capable of receiving the cartridge and comprising means for securing the cartridge such that the blade projects below the bottom of the footblock; and
a gantry attached to the footblock and capable of moving the footblock so that the blade travels along a desired cutting path.

18. The paper cutting system of claim 17, wherein the blade is secured in the cartridge by projections carried by the cartridge that protrude through close fitting vacancies in the body of the blade.

19. A method for cutting matboard comprising:
inputting into a system control device a desired shape to be cut in a matboard, the system control device being capable of controlling the movement of a matboard cutting system and;
moving the matboard cutting system as a result of the input into the system control device, such that matboard is cut in the desired shape, wherein the matboard cutting system comprises:
a blade;
an elongated cartridge comprising a blade cavity capable of closely receiving the blade, the blade cavity comprising means for fastening the blade securely at an azimuthal angle of between 5 and 90 degrees, a footblock having a cartridge slide capable of receiving the cartridge and comprising means for securing the cartridge such that the blade projects below the bottom of the footblock; and
a means for moving the footblock so that the blade travels along a cutting path.

20. The matboard cutting system of claim 19, wherein the blade has a double-edged cutting tip and is secured at an azimuthal angle of 90 degrees.

21. An elongated blade for use in a matboard cutting device, comprising
two cutting edges, each cutting edge having a double-beveled shape; and
a first vacancy and a second vacancy used to retain the blade in a matboard cutting device, wherein at least one of the first vacancy and the second vacancy are offset from a centerline bisecting the length of the blade.

22. The blade of claim 20, wherein the two cutting edges intersect at an angle of about 45 degrees.

23. The blade of claim 20, wherein the blade is capable of use in a blade cartridge of claim 1.
